(19) United States
(12) Patent Application Publication
(10) Pub. No.: US 2006/0251103 A1
(43) Pub. Date: Nov. 9, 2006

(54) Apparatus and method for reattempting to execute command in network management system

(76) Inventor: Joo-Min Lee, Yongin-si (KR)

Correspondence Address: Robert E. Bushnell, Suite 300, 1522 K Street, N.W., Washington, DC, 20005, US

(21) Appl. No.: 11/400,274

(22) Filed: Apr. 10, 2006

(30) Foreign Application Priority Data
May 9, 2005 (KR) 10-2005-0038608

(51) Int. Cl. H04L 12/413

(52) U.S. Cl. 370/447

(57) ABSTRACT

An apparatus and method for reattempting to execute a command in a network management system include in reattempting execution of the command in the network management system, a reattempt period is increased as a reattempt count increase. Thereby, system and network resources used to reattempt the execution of the command are conserved and used more efficiently.

### CLAIM OF PRIORITY

This application makes reference to, incorporates the same herein, and claims all benefits accruing under 35 U.S.C. §119 from an application for APPARATUS AND METHOD FOR RETRYING FUNCTION filed in the Korean Intellectual Property Office on May 9, 2005 and there duly assigned Serial No. 10-2005-0038608.

### BACKGROUND OF THE INVENTION

1. Field of the Invention

The present invention relates to an apparatus and method for reattempting to execute a command in a network management system (NMS), and more particularly, to an apparatus and method for reattempting to execute a command in an NMS capable of reducing load on the NMS and the network.

2. Description of the Related Art

Network management refers to monitoring network resources for troubleshooting, potential problem discovery, performance improvement, documenting, reporting, and so on. Network management has various facets, such as performance management, analysis of resources and protocols, bandwidth management, capacity planning, simulation, and so forth. Conventionally, since the structure of a network was relatively simple, the network could be easily managed.

However, networks have become more complicated over time and their rate of change has become quite rapid as well. Currently, requirements related to the Internet and multimedia have increased, such as customers wanting to receive certain services without interruption anytime and anywhere. Thus, there is need of a next generation network (NGN) that can meet such requirements. Wired and wireless integrated services which combine the broadband capability of a wired network with the mobility of a wireless network are showing up. A separate communication equipment component should be designed for each service because an NGN must enable the provision of different services (e.g., voice, data, multimedia, etc.) through one integrated network. Further, there is a current trend toward developing packet networks. Thus, structurally, it is practically impossible to convert all current networks into IP-based packet networks at once. For this reason, it is essential for an NGN to include elements for interworking with existing networks. In this manner, the networks are complicated and quickly developed.

Meanwhile, as the complexity of networks increases, the quantity of commands for managing the networks increases exponentially. In addition, as the quantity of network managing commands increases, the quantity of resources required to execute these commands also increases. A representative example is bandwidth. An increase in commands to be transmitted requires an increase in bandwidth used to transmit the commands. For this reason, load on the bandwidth increases and the bandwidth may be insufficient, which may lead to failure in transmission of important commands or information. An increase in commands to be processed affects resources other than bandwidth as well.

In addition, there is another factor causing increase in commands to be processed. The factor is reattempting to execute a failed command. In general, when an attempt to execute a certain command meets with failure, the execution of the command is reattempted. The reattempt to execute the failed command is generally performed a preset number of times at a constant time interval. This reattempt to execute the command also occupies a certain quantity of resources including bandwidth, and therefore adds to the load on the system. In a conventional command execution reattempt scheme, the original command and each subsequent command to reattempt execution of the original command remain in effect and therefore consume resources even as further subsequent commands to reattempt execution of the original command are issued. Thus, there is a high probability of a sharp increase in overall bandwidth usage due to such compounding of reattempt commands. When the network is not operated well, such compounding of reattempt commands can occur and cause network congestion.

Congestion and wasting of resources can occur in all systems including the NMS. Thus, there is need for an apparatus and method for efficiently reattempting execution of failed commands so that congestion and wasting of resources are prevented.

### SUMMARY OF THE INVENTION

It is an objective of the present invention to provide an apparatus and method for reattempting to execute a command capable of reducing waste and improving usage efficiency of system resources.

It is another objective of the present invention to provide an apparatus and method for reattempting to execute a command in a network management system (NMS) capable of improving usage efficiency of network resources.

It is yet another objective of the present invention to provide an apparatus and method for reattempting to execute a command in a network management system capable of improving usage efficiency of network bandwidth.

According to an aspect of the present invention, there is provided an apparatus for reattempting to execute a command in a network management system. The apparatus includes: a command generator reattempting to execute the command on the basis of a reattempt period; and a command generation adjustor adjusting the reattempt period according to a predetermined rule.

According to another aspect of the present invention, there is provided a method for reattempting to execute a command in a network management system. The method includes: a first step of transmitting the command through a network; a second step of waiting for a response to the command for a reattempt period determined by a current reattempt count; and a third step of repeating the first and second steps when the response to the command is not received before the reattempt period lapses.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram showing connection of an NMS and an element management system (EMS) to which the present invention can be applied;

FIG. 2 is a block diagram of an apparatus for reattempting to execute a command in an NMS in accordance with an exemplary embodiment of the present invention;

FIGS. 3A and 3B are graphs showing correlation between a command execution reattempt count and a bandwidth usage rate; and

FIG. 4 is a flowchart illustrating a method for reattempting to execute a command in an NMS according to an exemplary embodiment of the present invention.

### DETAILED DESCRIPTION OF THE PREFERRED EMBODIMENTS

An objective of the present invention is a more efficient use of network resources such as bandwidth. To this end, the present invention provides an apparatus and method for executing a command in a network management system (NMS), in which when reattempting to execute a command whose execution failed the first time, a reattempt time interval gradually increases.

Hereinafter, exemplary embodiments of the present invention will be described in detail with reference to the accompanying drawings. Throughout the drawings, the same reference numerals or characters are used to designate the same elements or similar elements having the same function. Also, matters that are well known in the art will not be described below in order to keep the description of the present invention clear and concise.

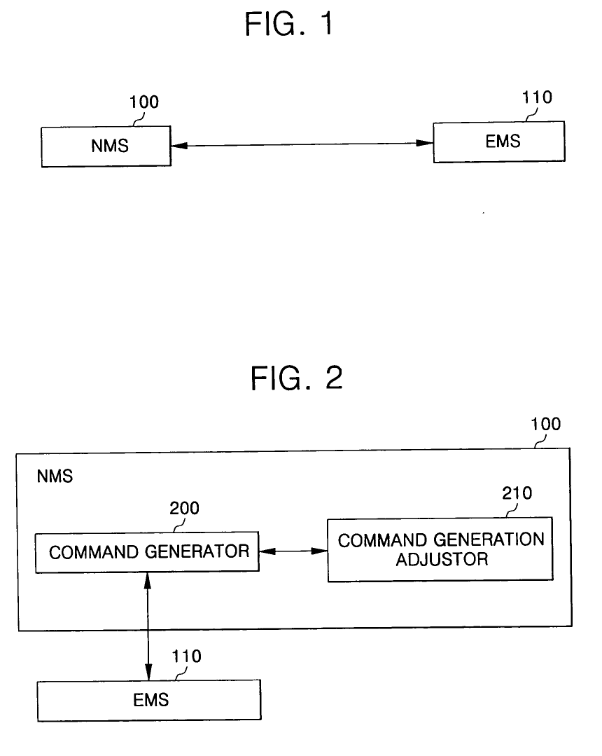

FIG. 1 is a block diagram showing connection of an NMS and an element management system (EMS) to which the present invention can be applied.

An NMS 100 and an EMS 110 are systems used for management of a network.

A variety of commands are processed between the NMS 100 and the EMS 110. In the event of failure to execute a command, command execution is reattempted according to a predetermined rule. In general, when command execution is reattempted between the NMS 100 and the EMS 110, two main items are set: one is a reattempt period, which may be thought of as a response standby time, and the other is a reattempt number or count, which specifies the number of command execution reattempts, which use up network bandwidth. In the equations provided below, the reattempt period is denoted by “P” and the reattempt count by “C”. Further, an indicator showing a bandwidth usage rate is denoted by “I”.

The NMS 100 or EMS 110 that transmits a command through the network waits for a response. When there is no response, the corresponding system waits for a preset period of time, and then reattempts to execute the command. A reattempt command is transmitted through the network and the system waits for a response again.

Here, the relationship between the reattempt period, the reattempt count, and the bandwidth usage rate is given by Equation 1:

$$I = \frac{C}{P} \qquad Equation 1$$

As shown in Equation 1, I is inversely proportional to P and directly proportional to C.

The present invention reduces waste of resources and prevents congestion by varying the reattempt period when the system reattempts to execute the command. For example, when execution of the command is reattempted, a user waits for a response for a preset time period after the first reattempt, and the system increases the reattempt period on the basis of a rule starting from the second reattempt. In this case, as the number of reattempts increases, the reattempt period is increased. Consequently, even when execution of a plurality of commands is reattempted, the reattempt interval is increased in proportion to lapse of time, and bandwidth usage is reduced. Further, a bandwidth interference rate between the commands is lowered. The command execution reattempting apparatus and method of the present invention in which the reattempt period is adjusted in this manner will be described with reference to FIG. 2. Below, the present invention will be described by taking the command execution reattempting apparatus positioned at the NMS 100 as an example.

FIG. 2 is a block diagram of an apparatus for reattempting to execute a command in an NMS (network management system) in accordance with the present invention.

As shown in FIG. 2, the command execution reattempting apparatus of the present invention may be constructed to include a command generator 200 and a command generation adjustor 210. The command generator 200 attempts to execute a command, and when execution of the command fails, reattempts to execute the command on the basis of a preset reattempt period and a reattempt count. The command generation adjustor 210 adjusts the reattempt period and the reattempt count, which serve as the basis of the reattempt to execute the command, to the command generator 200 on the basis of a predetermined rule. The predetermined rule that the command generation adjustor 210 uses may be variously determined according to characteristics of the system.

The command execution reattempting apparatus positioned at the NMS 100 has been described up to now. However, the command execution reattempting apparatus of the present invention may be positioned at the EMS (element management system) 110 rather than the NMS 100. Even when the command execution reattempting apparatus of the present invention is positioned at the EMS 110, it has the same configuration and operation as described above. Furthermore, the command execution reattempting apparatus of the present invention may be positioned at any apparatus that issues/executes commands. In which case of the command execution reattempting apparatus being positioned at any apparatus that issues/executes commands, the command execution reattempting apparatus of the present invention may also have the same configurations and operation as described above.

Rules used in the present invention to adjust the reattempt period will now be illustrated.

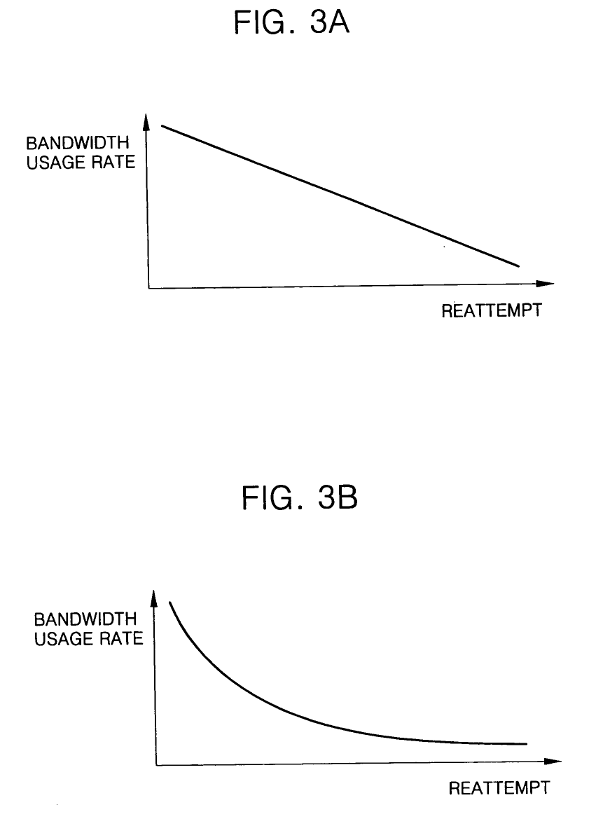

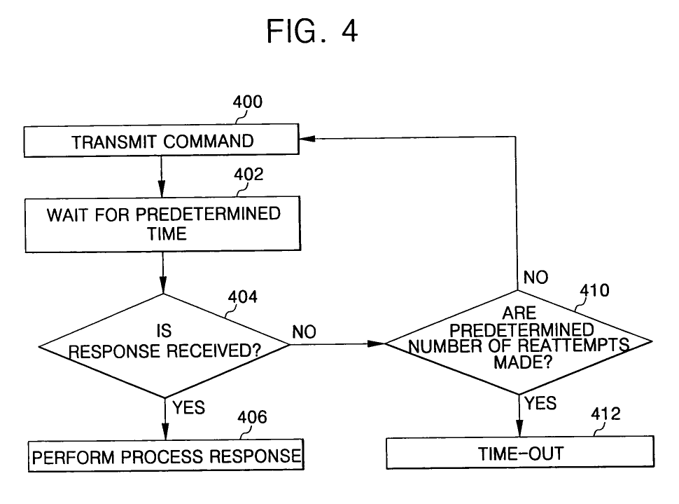

FIGS. 3A and 3B are graphs showing correlation between the command execution reattempt count and the bandwidth usage rate.

In particular, FIG. 3A shows linear decrease in a bandwidth usage rate as a reattempt count increases, and FIG. 3B shows hyperbolic decrease in a bandwidth usage rate as a reattempt count increases.

These graphs show examples of a reattempt period adjusting rule used by the command execution reattempting apparatus of the present invention to increase the reattempt period according to the reattempt count. According to characteristics of the system, other rules may be used. Hereinafter, the reattempt period adjusting rule will be described in detail through Equation 2 expressing correlation between the reattempt period, the reattempt count, and the bandwidth usage rate as an example.

$$I = \frac{{C}_{i}}{{P}_{i} \times {W}^{x - 1}} \qquad Equation 2$$

Equation 2 is an example of the rule used to increase the reattempt period according to the present invention. In Equation 2, I is the indicator showing the bandwidth usage rate, Pᵢ is an initial setup value of the reattempt period, Cᵢ is an initial setup value of the reattempt count, and X is a current reattempt count. In contrast, the reattempt count, C, indicates the maximum number of reattempts that can be made. W is a weight value added to increase the period. Equation 2 sets the correlation between the reattempt period, the reattempt count, and the bandwidth usage rate in the exponential form shown in FIG. 3B.

Further, the present invention may use the following Equations 3 as a rule.

$$I = \frac{{C}_{i}}{{P}_{i} \times W ( X - 1 )} , and I = \frac{{C}_{i} \times W ( X - 1 )}{{P}_{i}} \qquad Equation 3$$

Equations 3 have hyperbolic and linear forms and require that X≧2.

The NMS 100 or EMS 110 that transmits the command through the network waits for a response. When there is no response, the corresponding system waits for a preset period Pᵢ and then reattempts execution of the command. A reattempt command is transmitted through the network and the system waits for a response again. Here, the period for waiting for a response is equal to the product of Pi and W. The system waits for the period and then reattempts again. In other words, as time passes, the reattempt period of the command gradually increases. Here, the period can be set so that the graph of the indicator I of the bandwidth usage rate versus current reattempt count X has an exponential or hyperbolic form, etc. The maximum reattempt count C can be set as a linear function. Specifically, the period can be varied between Pᵢ×W^{X-1} and Pᵢ×W(X−1) types, and the reattempt count can be varied in a type of Cᵢ−W(X−1). In addition, the present invention may apply various reattempt period setup rules. A command execution reattempting method according to the present invention will be described below.

FIG. 4 is a flowchart of a method of reattempting to execute a command in an NMS according to the present invention.

In step 400 of FIG. 4, a command execution reattempting apparatus of the present invention generates a command and transmits it to a corresponding system through a network. In step 402, the command execution reattempting apparatus waits for a response to the command for a predetermined time. When no response to the command is received before the predetermined time lapses, the command execution reattempting apparatus regards the command as a failure. As in step 404, when a response to the command is received, the command is not reattempted. Therefore, in step 406, the command execution reattempting apparatus processes the received response to the command.

Meanwhile, when the response to the command is not received, execution of the command is reattempted according to a predetermined rule. The command execution reattempting method of the present invention will be described below with reference to FIG. 4.

In step 410, the command execution reattempting apparatus determines whether or not execution of the command is reattempted a predetermined number of times. If execution of the command has already been reattempted the predetermined number of times, the command execution reattempting apparatus stops reattempting to execute the command, and in step 412, the command is regarded to be timed-out.

In step 410, if it is determined that execution of the command is not reattempted the predetermined number of times, the command execution reattempting apparatus goes back and repeats the method starting from step 400 of re-transmitting the command. At this time, the predetermined time in step 402 is the reattempt period that is adjusted by a rule such as described above.

Through these steps, the command execution reattempting method of the present invention can reattempt to execute a command in such a manner that, as the reattempt count increases, the reattempt period increases.

In the foregoing description of the apparatus and method for reattempting the command of the present invention, the apparatus and method decrease waste and increase usage efficiency of bandwidth by increasing the reattempt period together with the reattempt count. However, this is simply taken as an example of a resource conserved by the present invention, which can have the same effect on other resources as well.

It has been described so far that the present invention increase the reattempt period as the reattempt count increases. That is considered to be the most effective method for preventing congestion and conserving system resources. However, to be precise, one of the most prominent features of the present invention is that it varies (not necessarily increases) the reattempt period as the reattempt count increases. Therefore, the present invention may be expanded and applied to vary the period based on the reattempt count according to some rule appropriate to the characteristic of the system.

As can be seen from the foregoing, the present invention increases the reattempt period as the reattempt count increases when reattempting execution of commands of various systems such as NMS, EMS, etc., thereby conserving and efficiently using system and network resources such as bandwidth.

According to the method of the present invention, a command to reattempt execution of a command is given after a wait that is longer by a weight value than a preceding wait before giving a preceding reattempt command, thereby minimizing congestion of bandwidth.

Further, when a large number of commands are timed-out due to disconnection from the network, continuous reattempting to execute later commands can be suspended based on the time-out of previous commands, thereby improving the efficiency of time-out processing between NMS and EMS.

The present invention can also be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

An example of a computer, but not limited to this example of the computer, that can read computer readable media that includes computer-executable instructions of the present invention includes a processor that controls the computer. The processor uses the system memory and a computer readable memory device that includes certain computer readable recording media. A system bus connects the processor to a network interface, modem or other interface that accommodates a connection to another computer or network such as the Internet. The system bus may also include an input and output interface that accommodates connection to a variety of other devices.

While exemplary embodiments of the present invention have been described, it will be understood by those skilled in the art that the present invention is not limited to the described exemplary embodiments. Rather, various changes and modifications can be made within the spirit and scope of the present invention as defined by the following claims.

What is claimed is:

1. An apparatus for reattempting to execute a command in a management system, the apparatus comprising:
a command generator reattempting to execute the command on the basis of a reattempt period; and
a command generation adjustor adjusting the reattempt period of said command generator according to a predetermined rule.

2. The apparatus of claim 1, wherein said command generation adjustor increases the reattempt period as a reattempt count of the command increases.

3. The apparatus of claim 1, wherein said command generation adjustor adjusts the reattempt period of the command on the basis of the following equation:
$$I = \frac{{C}_{i}}{{P}_{i} \times {W}^{x - 1}}$$
wherein I is an indicator of a bandwidth usage rate, Cᵢ is an initial setup value of a maximum reattempt count, Pᵢ is an initial setup value of the reattempt period, W is a weight value, and X is a reattempt count.

4. The apparatus of claim 1, wherein said command generation adjustor adjusts the reattempt period of the command on the basis of the following equation:
$$I = \frac{{C}_{i}}{{P}_{i} \times W ( X - 1 )}$$
wherein I is an indicator of a bandwidth usage rate, Cᵢ is an initial setup value of a maximum reattempt count, Pᵢ is an initial setup value of the reattempt period, W is a weight value, and X is a reattempt count.

5. The apparatus of claim 1, wherein said command generation adjustor adjusts the reattempt period of the command on the basis of the following equation:
$$I = \frac{{C}_{i} \times W ( X - 1 )}{{P}_{i}}$$
wherein I is an indicator of a bandwidth usage rate, Cᵢ is an initial setup value of a maximum reattempt count, Pᵢ is an initial setup value of the reattempt period, W is a weight value, and X is a reattempt count.

6. The apparatus of claim 1, wherein said command generator reattempts to execute the command within a number of times not exceeding a predetermined maximum reattempt count.

7. The apparatus of claim 1, wherein said management system being a network management system.

8. The apparatus of claim 1, wherein:
said management system being one of a network management system, element management system, and device issuing and executing commands; and
said predetermined rule applied by said command generation adjustor including the bandwidth usage rate being inversely proportional to the reattempt period and directly proportional to the reattempt count.

9. The apparatus of claim 1, wherein said predetermined rule varying the reattempt period as a reattempt count increases.

10. A method for reattempting to execute a command in a network management system, the method comprising:
transmitting the command through a network;
waiting for a response to the command for a reattempt period determined by a current reattempt count of the command; and
repeating said transmitting of the command and said waiting for the response to the command, when the response to the command is not received before the reattempt period lapses.

11. The method of claim 10, wherein the reattempt period in said waiting for the response to the command, is increased as the reattempt count increases.

12. The method of claim 10, wherein the reattempt period is adjusted on the basis of the following equation:
$$I = \frac{{C}_{i}}{{P}_{i} \times {W}^{x - 1}}$$
wherein I is an indicator of a bandwidth usage rate, Cᵢ is an initial setup value of a maximum reattempt count, Pᵢ is an initial setup value of the reattempt period, W is a weight value, and X is the current reattempt count.

13. The method of claim 10, wherein the reattempt period is adjusted on the basis of the following equation:
$$I = \frac{{C}_{i}}{{P}_{i} \times W ( X - 1 )}$$
wherein I is an indicator of a bandwidth usage rate, Cᵢ is an initial setup value of a maximum reattempt count, Pᵢ is an initial setup value of the reattempt period, W is a weight value, and X is the current reattempt count.

14. The method of claim 10, wherein the reattempt period is adjusted on the basis of the following equation:
$$I = \frac{{C}_{i} \times W ( X - 1 )}{{P}_{i}}$$
wherein I is an indicator of a bandwidth usage rate, Cᵢ is an initial setup value of a maximum reattempt count, Pᵢ is an initial setup value of the reattempt period, W is a weight value, and X is the current reattempt count.

15. The method of claim 10, wherein said repeating of said transmitting of the command and said waiting for the response to the command is performed only when the current reattempt count of the command is less than a maximum reattempt count, and reattempting to execute the command is stopped when the current reattempt count reaches the maximum reattempt count.

16. The method of claim 10, wherein varying the reattempt period according to a reattempt count.

17. The method of claim 10, wherein when executing a plurality of commands being timed-out due to disconnection from the network, continuous reattempting to execute later commands being suspended according to time-out of previous plurality of commands.

18. The apparatus of claim 10, wherein varying the reattempt period according to an increasing reattempt count, the varying being according to the characteristics of said network management system.

19. A computer-readable medium having computer-executable instructions for performing the method of claim 10.

20. A computer-readable medium having stored thereon a data structure comprising:
a first field containing data representing transmitting the command through a network;
a second field containing data representing waiting for a response to the command for a reattempt period determined by a current reattempt count of the command; and
a third field containing data representing repeating said transmitting of the command and said waiting for the response to the command, when the response to the command is not received before the reattempt period lapses, with varying the reattempt period according to an increasing reattempt count where the bandwidth usage rate is inversely proportional to the reattempt period and directly proportional to the reattempt count.
